(19) United States
(12) Patent Application Publication
(10) Pub. No.: US 2016/0063620 A1
(43) Pub. Date: Mar. 3, 2016

(54) SYSTEM AND METHOD OF FACILITATING PAYDAY LOANS

(71) Applicants: Bruce E. MCLEAN, Langley (CA); Donald M. HARVEY, Burnaby (CA)

(72) Inventors: Bruce E. MCLEAN, Langley (CA); Donald M. HARVEY, Burnaby (CA)

(21) Appl. No.: 14/380,682

(22) PCT Filed: Mar. 1, 2012
(86) PCT No.: PCT/CA2012/000197

§ 371 Date: Nov. 18, 2015

(51) Int. Cl. G06Q 40/02; G06Q 20/10

(52) U.S. Cl. CPC G06Q 40/025; G06Q 20/10

(57) ABSTRACT

A loan facilitation system and method facilitates payday loan transactions by establishing a loan access account at a loan facilitation server. The loan facilitation server communicates with a loan operator server and a financial institution server to manage funds in a pooled account at the financial institution. The funds being cleared funds and associated with one or more loan access accounts, which are associated with customer accounts of a payday loan operator.

### TECHNICAL FIELD

The present application relates to systems and methods for facilitating payday loan transactions.

### BACKGROUND DISCUSSION

From time to time, consumers are faced with an urgent need for cash to cover living expenses or unexpected expenses such as car repairs or heath care costs, for example. Many of these consumers have low credit ratings, which may limit their ability to obtain loans from financial institutions.

Payday loans operators cater to consumers who are looking for alternative sources of cash. Currently, consumers must appear in person at a payday loan operator location to sign a loan agreement that specifies the conditions of the loan including the interest rate and due date for repayment. This process is often tedious and time consuming particularly for repeat payday loan customers.

### SUMMARY

In an aspect of the present disclosure there is provided a method including: sending over a network, from a loan facilitation server in communication with a server of a financial institution, loan operator identification data to the server for establishing a pooled account at the financial institution, funds in the pooled account being cleared funds; receiving, at the loan facilitation server, a loan access account data from a loan operator server for establishing a loan access account, the loan access account being associated with a customer account stored on the loan operator server, the loan facilitation server communicating with the loan operator server over the network; sending, from the loan facilitation server, a subset of the loan access account data to the server of the financial institution, the subset of the loan access account data for associating the customer account with the pooled account; wherein the pooled account comprises funds received by electronic funds transfer associated with multiple loan access accounts and the funds are aggregated funds of the multiple loan access accounts.

In another aspect of the present disclosure there is provided a system including: a loan facilitation server; a loan operator server in communication with the loan facilitation server over a network, the loan operator server for sending loan access account data associated with a customer account stored on the loan operator server to the loan facilitation server, a loan access account comprising the loan access account data being established at the loan facilitation server; a financial institution server in communication with the loan facilitation server over the network, the financial institution server receiving loan operator identification data for establishing a pooled account at the financial institution and receiving a subset of the loan access account data for associating the loan access account with the pooled account, funds in the pooled account being cleared funds; wherein the pooled account is associated with multiple loan access accounts and the funds are aggregated funds of the multiple loan access accounts.

In yet another aspect of the present disclosure there is provided a method including: determining a monetary value of an item received by a credit generating device using an item identification device in electrical communication with a processor of the credit generating device; storing a monetary value associated with the item in a memory of the credit generating device, the memory being in electrical communication with the processor; receiving a debit card in a card reader of the credit generating device, the card reader in electrical communication with the processor; and crediting an account associated with the debit card with funds corresponding to the monetary value.

In still another aspect of the present disclosure there is provided a credit generating machine including: an input device for receiving an item and assigning a monetary value to the item; a card reader for reading a debit card; a processor in electrical communication with the input device and the card reader; wherein an account associated with the debit card is creditable with funds having a value equal to the monetary value.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present application will now be described, by way of example only, with reference to the attached Figures, wherein:

FIG. 1 is a schematic block diagram of a loan facilitation system for payday loans according to an embodiment;

FIG. 2 is a flow chart illustrating a method of facilitating a payday loan;

FIG. 3 is another schematic block diagram of a loan facilitation system for payday loans;

FIG. 4 is a schematic diagram depicting transactions with the loan facilitation system using a debit card;

FIG. 5 is a schematic diagram depicting transactions with the loan facilitation system using a mobile application;

FIG. 6 is a flow chart illustrating a method of pre-approving a new loan using the loan facilitation system;

FIG. 7 is a schematic diagram depicting transactions with the loan facilitation system using a debit card at a credit generating device; and

FIG. 8 is a schematic diagram depicting transactions using a debit card associated with any bank account at a credit generating device.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

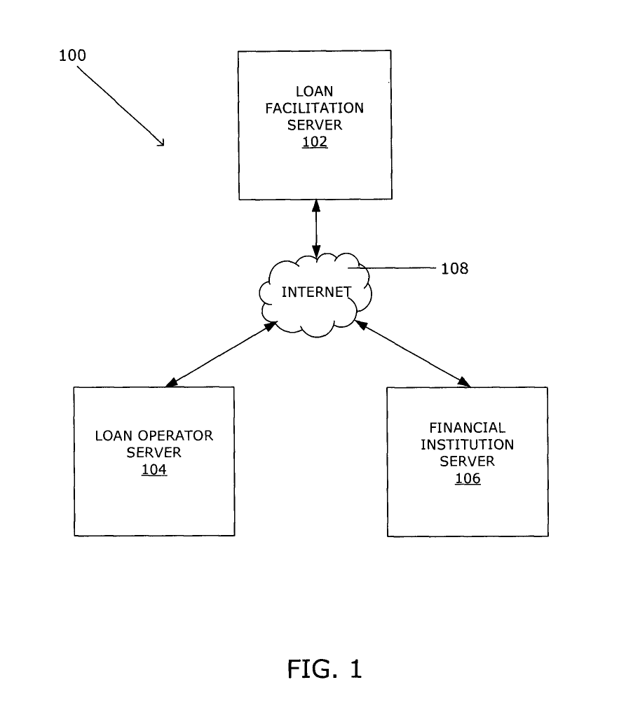

Referring to FIG. 1, a loan facilitation system 100 includes a loan facilitation server 102 in communication with a loan operator server 104 and a server 106 of a financial institution over the Internet 108. The communication may occur via a wired connection to the network or through a wireless connection.

The loan operator server 104 is maintained by a payday loan operator. Payday loan operators are independent companies that offer payday loan services to consumers. Multiple loan operator servers 104 maintained by multiple different payday loan operators may be in communication with the loan facilitation server 102. Regulations imposed by federal or other respective governments govern business conduct of payday loan operators.

The financial institution server 106 is maintained by a financial institution. Financial institutions are typically banks or credit unions that are subject to industry regulations. Multiple financial institution servers 106 maintained by multiple different financial institutions may be in communication with the loan facilitation server 102.

As will be understood by a person skilled in the art, all communication between the loan facilitation server 102 and the loan operator server 104 and between the loan facilitation server 102 and the financial institution server 106 is secure communication, which may be encrypted in accordance with standard financial transaction protocols.

The loan facilitation server 102 is maintained by a third party. The third party is not involved in granting loans or collecting loans that are in default. The function of the third party is to provide more convenient access to loaned funds of customers and provide some flexibility with respect to how the loan is repaid.

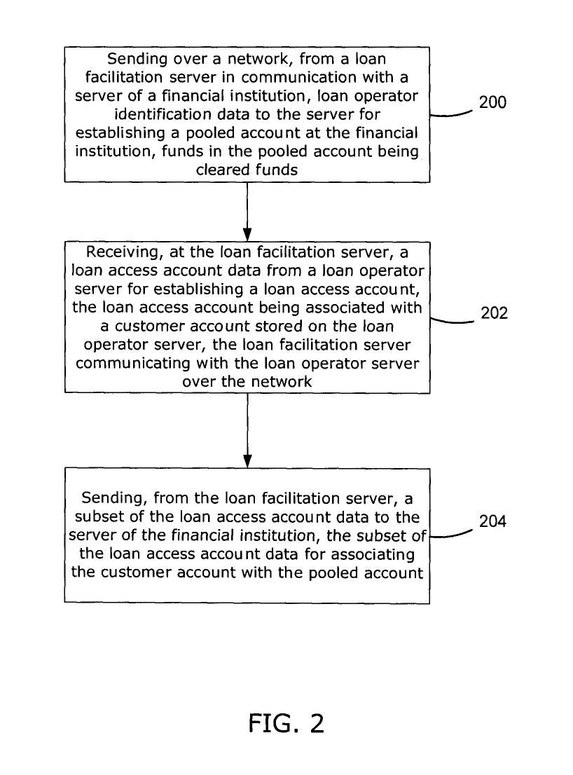

FIG. 2 is a flowchart illustrating an example of a method of facilitating payday loans. The method may be carried out by software executed by, for example, one or more processors of the loan facilitation server 102. Coding of software for carrying out such a method is within the scope of a person of ordinary skill in the art given the present description. The method may contain additional or fewer processes than shown and described, and may be performed in a different order. Computer-readable code executable by, for example, the processor to perform the method, may be stored in a computer-readable medium.

At 200, the loan facilitation server 102 sends loan operator identification data over a network 108 to a server 106 of a financial institution for establishing a pooled account at the financial institution. Funds are transferred into the pooled account via electronic funds transfer. The funds in the pooled account are cleared funds that are readily accessible and not subject to any hold periods imposed by the financial institution. At 202, the loan facilitation server 102 receives loan access account data, which is a subset of customer account data, from a loan operator server 104 over the network 108. The loan access account data is a portion of the information that is associated with a customer account stored on the loan operator server 104. At 204, the loan facilitation server 102 sends a subset of the loan access account data to the server 106 of the financial institution over the network 108. The loan access account data associates the loan access account with the pooled account at the financial institution, which may also be associated with other loan access accounts. When the pooled account is associated with multiple loan access accounts, the funds in the pooled account are aggregated funds of the multiple loan access accounts. Although the pooled account is described as being associated with one payday loan operator, the pooled account may be associated with more than one payday loan operator.

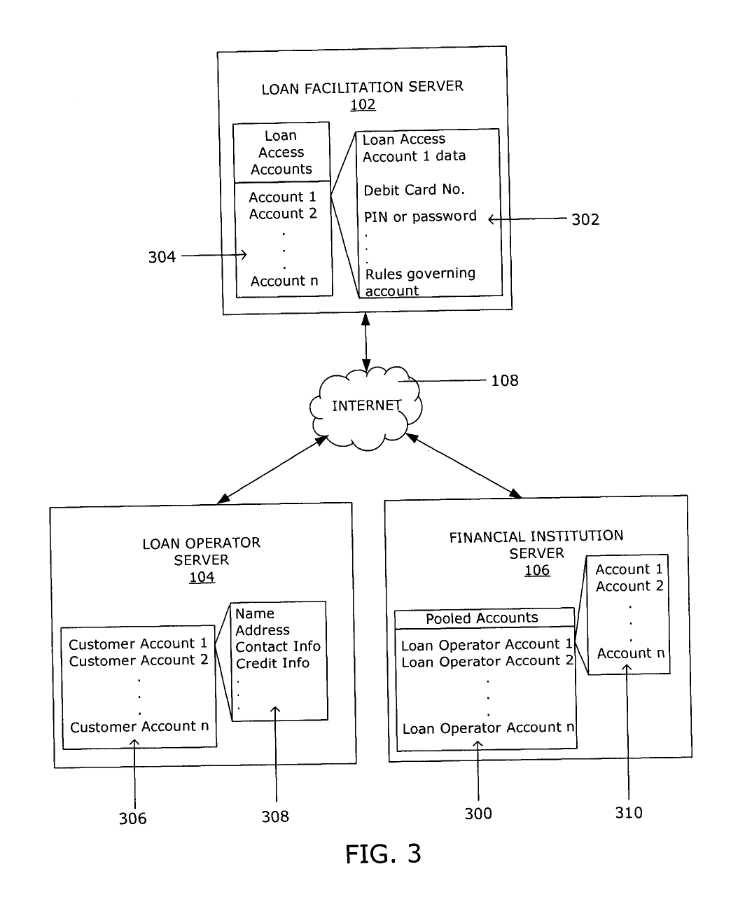

Continued reference is made to FIG. 2 with additional reference to FIG. 3 to describe one example of a method of facilitating payday loans. Typically, the method of FIG. 2 is performed following a request by a loan operator to use the services of the third party. First, the loan facilitation server 102 communicates with the financial institution server 106 to establish a loan operator pooled account 300 for one or more loan operators, at 202. There may be any number of loan operator pooled accounts 300, as shown. The loan facilitation server 102 then receives loan access account data 302. As shown, the loan access account data 302 is stored in association with a loan access account 304 at the loan facilitation server 102. The loan access account data 302 may be the same as customer data 308 that is associated with customer accounts 306 and stored on the loan operator server 104. Alternatively, the loan access account data 302 may be a subset of the local customer data 308. The loan access account data 302 may exclude information that individually identifies the loan operator customers. The loan facilitation server 102 then sends a subset 310 of the loan access account data 302 to the financial institution server 106, which is associated with the loan operator pooled accounts 300 at the financial institution server 106.

After a loan operator pooled account 300 and customer accounts 306 have been established, funds in the pooled account 300 may be accessed by the customers having linked loan access accounts 304. The funds may be accessed to perform transactions in a similar manner as funds in any financial institution account. Methods for accessing the funds include a debit card, Internet banking or telephone banking, for example. The debit card may be branded with the loan operator's name, logo or other marketing information.

Changes to any part of the local customer data 308 of a customer account 306 is relayed, if applicable, to the loan facilitation server 102 and the financial institution server 106.

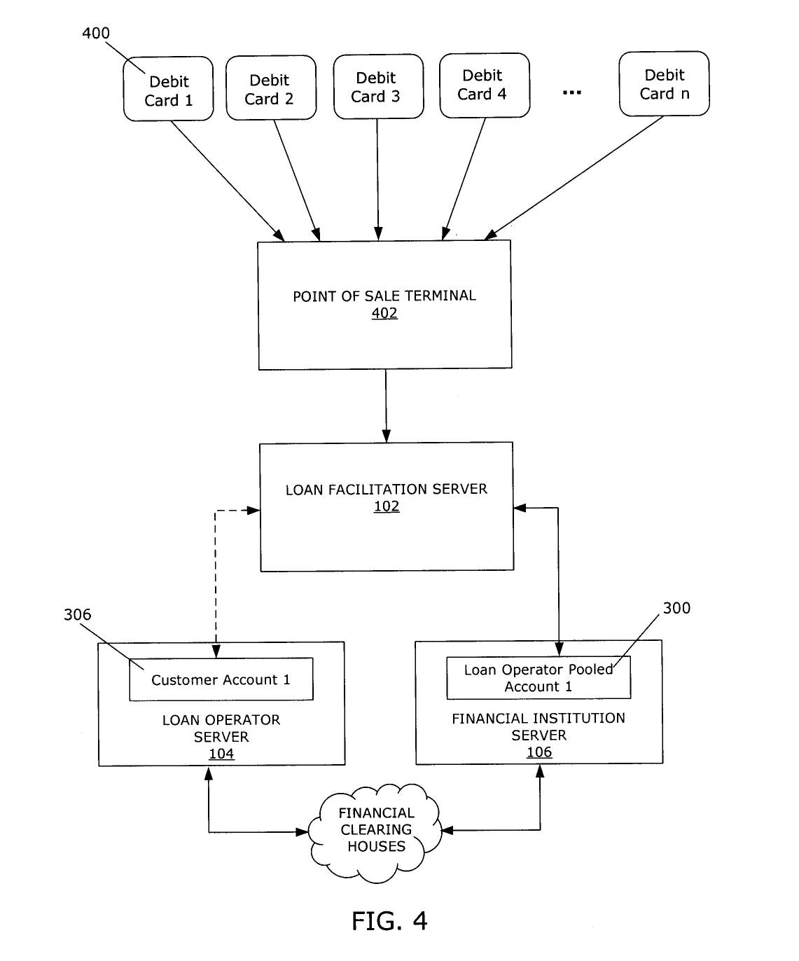

Referring to FIG. 4, debit cards 400 may be used to access funds from the loan operator pooled account 300. The debit cards 400 have unique debit card numbers and are associated with the loan access accounts stored on the loan facilitation server 102. The debit cards 400 may access the funds through a point of sale terminal 402, for example. Examples of point of sale terminals 402 include: Automated Teller Machines (ATMs), Merchant credit/debit machines, Internet transaction sites and vending machines. Although only one point of sale terminal 402 is shown in FIG. 4, a person skilled in the art will understand that the debit cards 400 may access the funds through any number of different point of sale terminals 402.

The loan facilitation server 102 authorizes transactions by validating the debit card number and a personal identification number (PIN) entered by a user at the point of sale terminal 402 with the available funds in the loan operator pooled account 300. The loan facilitation server 102 maintains a record of every transaction and the value of funds that are associated with each customer loan access account.

Transfer of funds using the debit cards occurs by way of Electronic Fund Transfer through financial clearing houses between a Merchant account (not shown) of the payday loan operator and the financial institution. Transactions are cleared through existing Financial Clearing House networks, typically every evening. Pending debit transactions such as Merchant purchases, bill payments and loan repayment, for example, debit a purchase amount including any transaction processing fees from the loan operator account pooled 300 and credit the purchase amount to a Merchant's transaction account, for example, and write a transaction record to the loan facilitation server 102. Pending credit transactions are handled in a similar manner. Credit transactions may occur as a result of a new payday loan from a loan operator, a refund from a Merchant or a deposit at an ATM. As indicated by the dashed line, the loan operator server 104 is able to access information at the loan facilitation server 102.

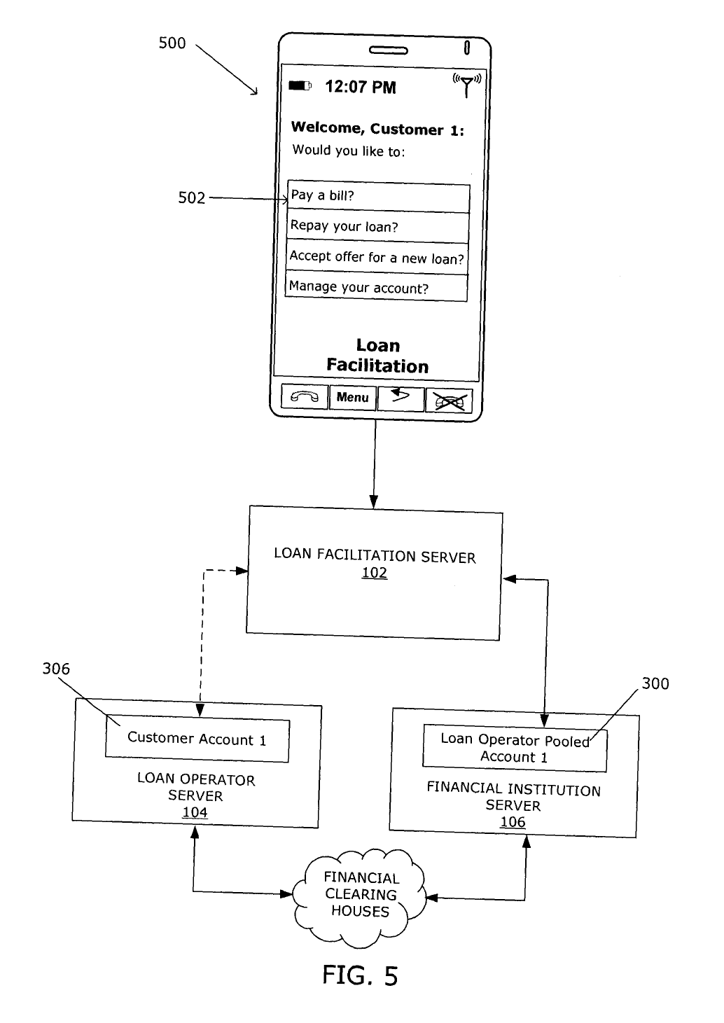

Referring to FIG. 5, a loan facilitation application executable on a mobile device 500 may be used to access funds over the Internet from the loan operator pooled account 300. Following initiation of a mobile device connection, which includes setting a password, a loan facilitation option may be added to a mobile device menu. The customer may log in to the loan access account by selecting a loan facilitation icon, entering an account number or debit card number and entering the password. The loan facilitation server 102 authorizes access to the loan access account by validating the account number or debit card number and the password. An example user interface of the loan facilitation application is shown including a menu 502 having selectable options, which is displayed on the mobile device 500. The menu may have more or fewer selectable options than those shown in FIG. 5. Transactions are processed in a similar manner as described for debit cards and therefore will not be described further here.

The customer may also access funds of the loan operator pooled account 300 over the Internet by navigating to a secure online website associated with the loan facilitation system. Customer validation is performed in a similar manner as described with respect to the mobile device application and transactions are processed as has previously been described.

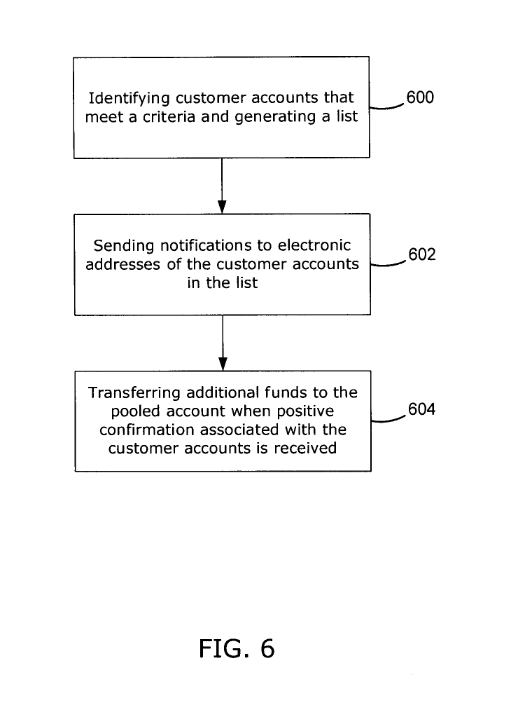

Referring to FIG. 6, a method of adding funds to the pooled account at the financial institution when a new loan is pre-approved is shown. The method may be carried out by software executed by, for example, one or more processors of the loan facilitation server 102. Coding of software for carrying out such a method is within the scope of a person of ordinary skill in the art given the present description. The method may contain additional or fewer processes than shown and described, and may be performed in a different order. Computer-readable code executable by, for example, the processor to perform the method, may be stored in a computer-readable medium.

At 600, customer accounts that meet a criteria specified by the loan operator are identified and a list is generated. The customer accounts are identified by searching customer account data. The criteria may include: number of previously repaid loans, number of loans within a particular period of time, duration of employment or geographic location, for example. At 602, notifications are sent to electronic addresses of the loan access accounts in the list to indicate that loan pre-approval criteria has been met. The electronic addresses may be e-mail addresses or SMS addresses, for example. Alternatively, the electronic address may be associated with the mobile application described in relation to FIG. 5. At 604, additional funds are approved for the loan access account when a positive confirmation is received from the electronic address and funds are transferred by electronic fund transfer to the applicable pooled account. In one embodiment, the list is approved by the loan operator prior to notifications being sent to electronic addresses of the loan access accounts.

In one embodiment, when the loan operator account is established at a financial institution at which the customer has an existing account, a previously issued debit card that is associated with the existing account may be further associated with the loan operator pooled account.

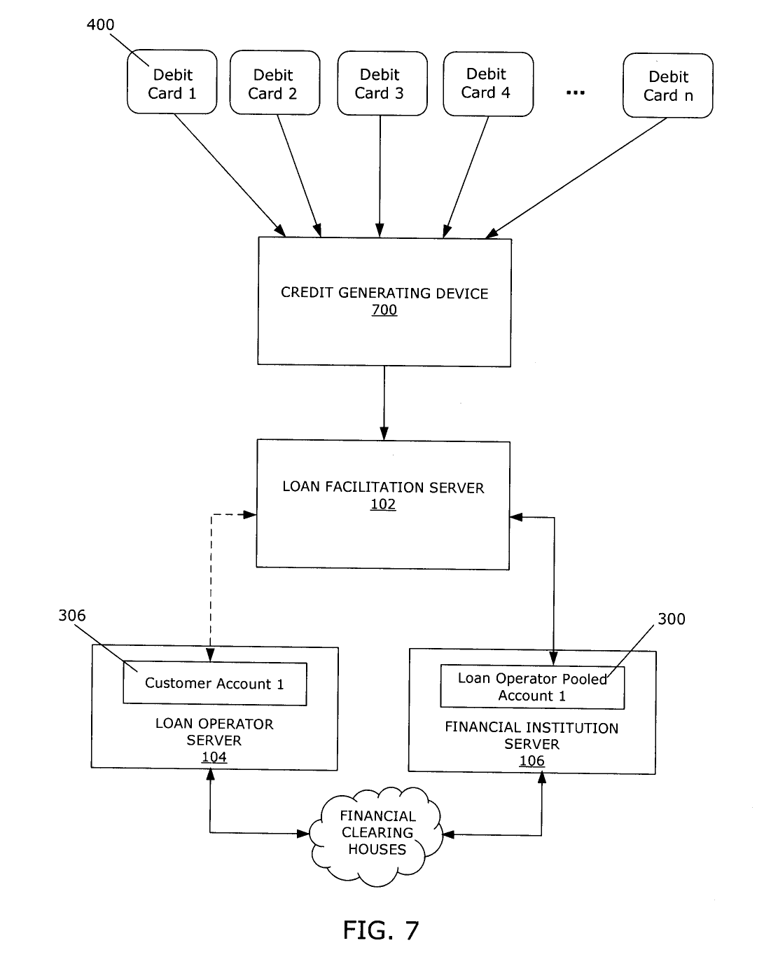

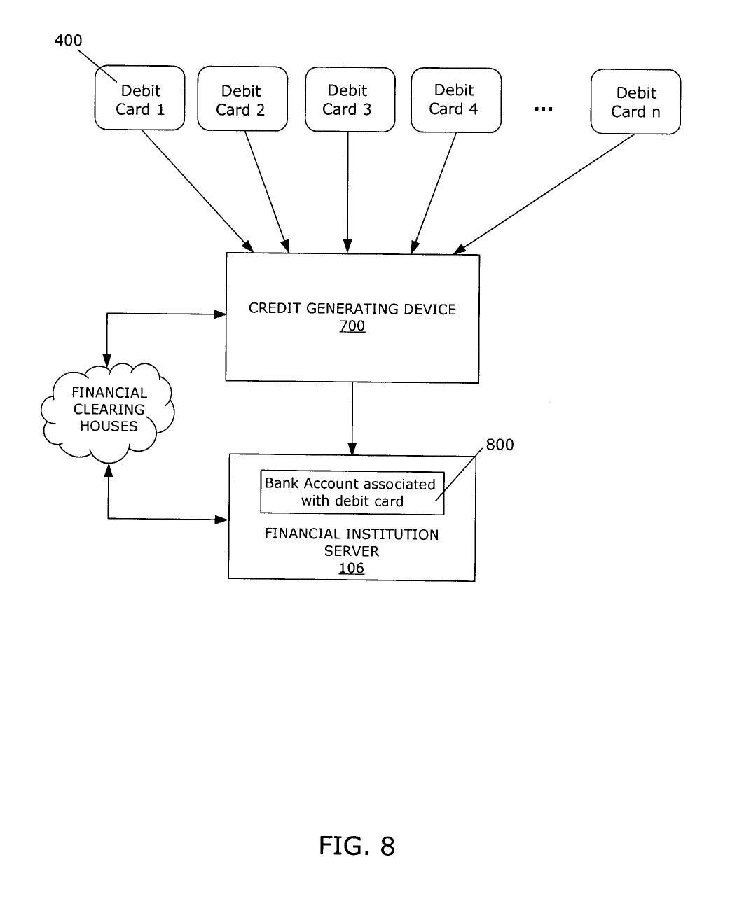

Debit cards 400 may also be used to credit funds obtained through a credit generating device 700 to the loan operator pooled account 300, as shown in FIG. 7, or directly from the credit generating device to any bank account, as shown in FIG. 8. The credit generating device 700 is electrically linked through the Internet or other communication network and is capable of electronic funds transfer similar to point of sale devices. As indicated by the dashed line of FIG. 7, the loan operator server 104 is able to access information at the loan facilitation server 102. The credit generating device may be any type of reverse vending machine such as machines for receiving loose coins and machines for receiving goods for recycling, such as plastic bottles, tires, light bulbs, batteries or aluminum cans, for example.

In the embodiment of FIG. 7, the loan facilitation server 102 authorizes transactions by validating the debit card number and a personal identification number (PIN) entered by a user at the credit generating device 700. The loan facilitation server 102 maintains a record of every transaction and the value of funds that are associated with each customer loan access account. Although only one credit generating device 700 is shown in FIG. 7, a person skilled in the art will understand that the debit cards 400 may credit funds through any number of different credit generating devices 700.

As has been previously described, transfer of funds using the debit cards occurs by way of Electronic Fund Transfer through financial clearing houses. Transactions are cleared through existing Financial Clearing House networks, typically every evening. Pending credit transactions credit the funds received from the credit generating device 700 to the pooled account 300 and write a transaction record to the loan facilitation server 102.

Operation of the credit generating device 700 includes: determining a monetary value of an item received by the credit generating device 700 using an item identification device in electrical communication with a processor of the credit generating device 700; storing a monetary value associated with the item in a memory of the credit generating device 700, the memory being in electrical communication with the processor; receiving a debit card in a card reader of the credit generating device 700, the card reader in electrical communication with the processor; and crediting a loan access account associated with the debit card with funds corresponding to the monetary value. The item may be a coin, a recyclable can or bottle, for example, that is received through an opening in the credit generating machine and identified using item identification technology that is known in the art. The method may be carried out by software. Coding of software for carrying out such a method is within the scope of a person of ordinary skill in the art given the present description. Computer-readable code executable by, for example, the processor to perform the method, may be stored in a computer-readable medium.

In the embodiment of FIG. 8, the credit generating device 700 authorizes transactions through financial clearing houses to a bank account 800 associated with the debit card so that credit generated is deposited in the bank account. The bank account may be a chequing account or a savings account, for example, held at a financial institution.

It will be appreciated by a person skilled in the art that the debit cards described may be magnetic strip-type debit cards or any other card that conforms to international standards for financial transaction processing.

The system and methods described herein provide increased convenience for the customer which may help the customer better manage his or her money. For example, the customer is able to repay small portions of the loan at intervals during the loan period without personally returning to the payday loan operator location, which may reduce the cost of borrowing money.

Because the majority of Payday Loan Operator customers are repeat customers, providing a convenient method for loan pre-approval saves customers time because they do not need to appear in person at the Payday Loan Operator location every two weeks or so to set up a new loan.

Other advantages may include: providing a new revenue source for loan operators through related transaction fees; reduced staffing and other operating expenses for loan operators; reduced cash on hand required at loan operator premises thereby reducing probability of theft and increasing employee safety; increased brand exposure by loan operators; increased convenience to customers by having 24/7 access to their loan access account information; increased convenience for customers by having 24/7 access to obtain cash from ATMs and other financial services such as bill payment and online purchases, for example.

The above-described embodiments are intended to be examples only. Alterations, modifications and variations can be effected to the particular embodiments by those of skill in the art without departing from the scope of the present application, which is defined solely by the claims appended hereto.

What is claimed is:

1. A method comprising:
sending over a network, from a loan facilitation server in communication with a server of a financial institution, loan operator identification data to the server for establishing a pooled account at the financial institution, funds in the pooled account being cleared funds;
receiving, at the loan facilitation server, a loan access account data from a loan operator server for establishing a loan access account, the loan access account being associated with a customer account stored on the loan operator server, the loan facilitation server communicating with the loan operator server over the network;
sending, from the loan facilitation server, a subset of the loan access account data to the server of the financial institution, the subset of the loan access account data for associating the customer account with the pooled account;
wherein the pooled account comprises funds received by electronic funds transfer associated with multiple loan access accounts and the funds are aggregated funds of the multiple loan access accounts.

2. A method as claimed in claim 1, wherein a debit card is associated with the loan access account for accessing the funds.

3. A method as claimed in claim 1, wherein the loan access account data is a subset of customer account data associated with the customer account stored on the loan operator server.

4. A method as claimed in claim 1, wherein following customer verification, funds are debited from the pooled account or funds are credited to the pooled account.

5. A method as claimed in claim 4, wherein customer verification comprises receiving, at the loan facilitation server, an identifier of the loan access account and a password and comparing the identifier of the loan access account and the password to stored values.

6. A method as claimed in claim 5, wherein the identifier is a debit card number and the password is a Personal Identification Number.

7. A method as claimed in claim 1, comprising pre-approving a new loan by identifying customer accounts that meet a criteria by searching customer account data, generating a list of customer accounts that meet the criteria, sending a notification through the loan facilitation server to corresponding electronic addresses of the loan access accounts in the list and transferring funds by electronic funds transfer to the pooled account in association with the loan access accounts when positive confirmation associated with the loan access accounts is received.

8. A method as claimed in claim 7, wherein the criteria is specified by the payday loan operator.

9. A method as claimed in claim 7, wherein the positive confirmation is received from the electronic address.

10. A method as claimed in claim 1, wherein a mobile application stored in memory of a mobile device and executable by a processor of the mobile device is associated with the loan access account for accessing the funds.

11. A non-transient computer-readable medium comprising instructions executable by the processor of the loan facilitation server for implementing the method of claim 1.

12. A system comprising:
a loan facilitation server;
a loan operator server in communication with the loan facilitation server over a network, the loan operator server for sending loan access account data associated with a customer account stored on the loan operator server to the loan facilitation server, a loan access account comprising the loan access account data being established at the loan facilitation server;
a financial institution server in communication with the loan facilitation server over the network, the financial institution server receiving loan operator identification data for establishing a pooled account at the financial institution and receiving a subset of the loan access account data for associating the loan access account with the pooled account, funds in the pooled account being cleared funds;
wherein the pooled account is associated with multiple loan access accounts and the funds are aggregated funds of the multiple loan access accounts.

13. A system as claimed in claim 12, wherein the loan facilitation server communicates with a point of sale terminal to debit or credit funds in the pooled account associated the loan access account.

14. A system as claimed in claim 12, wherein the loan facilitation server communicates with a credit generating device to credit funds in the pooled account associated the loan access account.

15. A system as claimed in claim 12, wherein a debit card is associated with the loan access account for accessing the funds.

16. A system as claimed in claim 12, wherein a mobile application stored in memory of a mobile device and executable by a processor of the mobile device is associated with the loan access account for accessing the funds.

17. A method comprising:
determining a monetary value of an item received by a credit generating device using an item identification device in electrical communication with a processor of the credit generating device;
storing a monetary value associated with the item in a memory of the credit generating device, the memory being in electrical communication with the processor;
receiving a debit card in a card reader of the credit generating device, the card reader in electrical communication with the processor; and
crediting an account associated with the debit card with funds corresponding to the monetary value.

18. A method as claimed in claim 17, wherein the account is a loan access account associated with a pooled account at a financial institution, the pooled account comprising cleared funds.

19. A method as claimed in claim 17, wherein the item is: a coin or a recyclable good.

20. A method as claimed in claim 19, wherein the recyclable good is any recyclable good receivable by a reverse vending machine.

21. A method as claimed in claim 17, wherein the pooled account comprises funds received by electronic funds transfer associated with multiple loan access accounts and the funds are aggregated funds of the multiple loan access accounts.

22. A method as claimed in claim 17, wherein the account associated with the debit card with funds corresponding to the monetary value is a bank account held at a financial institution.

23. A credit generating machine comprising:
an input device for receiving an item and assigning a monetary value to the item;
a card reader for reading a debit card;
a processor in electrical communication with the input device and the card reader;
wherein an account associated with the debit card is creditable with funds having a value equal to the monetary value.
